(19) United States
(12) Patent Application Publication
(10) Pub. No.: US 2016/0126073 A1
(43) Pub. Date: May 5, 2016

(54) PATHOLOGY INTERFACE SYSTEM FOR MASS SPECTROMETRY

(71) Applicant: VANDERBILT UNIVERSITY, Nashville, TN (US)

(72) Inventors: Jeremy L. Norris, Smyrna, TN (US); Erin H. Seeley, Nashville, TN (US); Tina Tsui, Brentwood, TN (US); Richard M. Caprioli, Brentwood, TN (US)

(21) Appl. No.: 14/895,939

(22) PCT Filed: Jun. 9, 2014
(86) PCT No.: PCT/US2014/041530

§ 371 Date: Dec. 4, 2015

Related U.S. Application Data
(60) Provisional application No. 61/832,379, filed on Jun. 7, 2013.

(51) Int. Cl. H01J 49/00; G01N 1/28

(52) U.S. Cl. CPC H01J 49/0004; G01N 1/286; G01N 2001/2886

(57) ABSTRACT

A diagnostic system and method that includes a non-transitory computer readable medium storing machine executable instructions executable by the processor for altering tissue images, the instructions that further includes an input interface configured to receive a plurality of tissue images, the input interface generating enhanced resolution images from the plurality of tissue images for viewing, an annotation interface for positioning coordinates of interest on the enhanced resolution images, and a matrix model configured to evaluate the coordinates of interest on the enhanced resolutions to generate discrete coordinates, the matrix model using the discrete coordinates in performing mass spectrometer analysis to form at least one viewing image. The system also includes a user interface configured to provide at least one viewing image to a user at the display.

### CROSS REFERENCES TO RELATED APPLICATIONS

The present application claims priority under 35 U.S.C. §371 to currently pending International Patent Application Serial No. PCT/US 14/XXX,XXX filed Jun. 9, 2014, which claims priority under 35 U.S.C. §119(e) to U.S. Provisional Patent Application Ser. No. 61/832,379 filed Jun. 7, 2013, both entitled PATHOLOGY INTERFACE FOR MASS SPECTROMETRY. The above-identified applications are incorporated herein by reference in their entirety for all purposes.

### GOVERNMENT FUNDING

This invention was made with government support under Grant Nos. National Center for Research Resources (5P41RR031461) and National Institute of General Medical Sciences (8P41GM103391) awarded by The National Institutes of Health. The United States government has certain rights to the invention.

### FIELD OF DISCLOSURE

The present disclosure relates to a pathology interface system for mass spectrometry (PIMS), and more specifically, a PIMS system that provides control, management, and dissemination of data associated with biomarking and/or annotating regions of interest in images associated with tissue sections and registering the annotated images.

### BACKGROUND

The application of imaging mass spectrometry (“IMS”) to clinical specimens such as animal or human tissue is an advancing frontier in diagnostic medicine. The molecular specificity of modern mass spectrometry provides unique insights into the biological mechanism for disease. For example, recent studies have demonstrated that histology-directed analyses of tissue sections using IMS can differentiate Spitz Nevi from Spitzoid melanoma based on molecular measurement.

Accordingly, IMS and histology-directed analysis of tissue sections can play a central role in the clinical studies relating to disease detection, diagnostics, control, and treatment. One type of IMS is a matrix-assisted laser desorption ionization mass spectrometry (“MALDI MS”). Further discussion of MALDI MS techniques and analysis is found in U.S. Patent Publication No. U.S. 2005/0029444 that published on Feb. 10, 2005 under application Ser. No. 10/880,750 entitled METHODS AND APPARATUSES FOR ANALYZING BIOLOGICAL SAMPLES BY MASS SPECTROMETRY and is assigned to the assignee of the present disclosure. The 2005/0029444 patent publication is incorporated herein by reference.

### SUMMARY

One aspect of the disclosure comprises a diagnostic system and method that includes a non-transitory computer readable medium storing machine executable instructions executable by the processor for altering tissue images, the instructions that further includes an input interface configured to receive a plurality of tissue images, the input interface generating enhanced resolution images from the plurality of tissue images for viewing, an annotation interface for positioning coordinates of interest on the enhanced resolution images, and a matrix model configured to evaluate the coordinates of interest on the enhanced resolutions to generate discrete coordinates, the matrix model using the discrete coordinates in performing mass spectrometer analysis to form at least one viewing image. The system also includes a user interface configures to provide at least one viewing image to a user at a display.

Another aspect of the disclosure comprises a system for controlling the acquisition of data from at least one tissue sample. The system comprises a pathology interface for receiving at least one tissue sample and provides the at least one tissue sample image to a user. The pathology interface is configured to position at least one coordinate of interest for the acquisition of data on the at least one tissue sample. The pathology interface is also configured to perform a controlled operation relating to at least one coordinate of interest to provide an enhanced image about the coordinate of interest.

Yet another aspect of the disclosure comprises a method of tissue imaging, the method comprising the steps of configuring an input interface to receive a plurality of tissue images, the interface generating enhanced resolution images from the plurality of tissue images for viewing. The method further comprises the step of positioning coordinates of interest with an annotation interface on the enhanced resolution images, the step of evaluating the coordinates of interest on the enhanced resolution images with a matrix model configured to generate discrete coordinates, and the matrix model using the discrete coordinates to perform mass spectrometry analysis to form at least one viewing image or provide molecular data to enhance the micrograph/photography. And, the step of displaying the viewing image to a user.

While another aspect of the disclosure comprises a diagnostic system comprising a processor, a display, and a non-transitory computer readable medium storing machine executable instructions executable by the processor for altering tissue images. The instructions comprise: an input interface configured to receive a plurality of tissue images, the input interface generating enhanced resolution images from the plurality of tissue images for viewing; an annotation interface for positioning coordinates of interest on the enhanced resolution images; a matrix model configured to evaluate the coordinates of interest on the enhanced resolution images to generate discrete coordinates, the matrix model using the discrete coordinates in performing mass spectrometer analysis to form at least one viewing image; and a user interface configured to provide at least one viewing image to a user at the display.

### BRIEF DESCRIPTION OF THE SEVERAL VIEWS OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1 is a work-flow diagram of a pathology interface system constructed in accordance with one example embodiment of the present disclosure;

FIG. 1A is a work-flow diagram of a pathology interface system constructed in accordance with another example embodiment of the present disclosure;

FIG. 1B is a work-flow diagram of a pathology interface system constructed in accordance with another example embodiment of the present disclosure;

FIG. 2 is a pathology interface system utilized by a network in accordance with another example embodiment of the present disclosure;

FIG. 3 is a work-flow diagram of a pathology interface system as utilized by another network in accordance with another example embodiment of the present disclosure;

FIG. 4A is a computer system used to implement a pathology interface system in accordance with one example embodiment of the present disclosure;

FIG. 4B is a block diagram of a pathology interface system used to control data acquisition from tissue using a mass spectrometer in accordance with one example embodiment of the present disclosure;

FIG. 5 is a work-flow project management process utilizing a pathology interface system in accordance with one example embodiment of the present disclosure;

FIG. 6 is a tissue sample of an enhanced image using the pathology interface system in accordance with one example embodiment of the present disclosure;

FIG. 7 is a work-flow diagram of a pathology interface process in accordance with one example embodiment of the present disclosure; and

FIG. 8 is a work-flow diagram of a pathology interface process in accordance with another example embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements having similar characteristics and operational properties throughout unless otherwise noted. The present disclosure relates to a pathology interface system for mass spectrometer (PIMS), and more specifically, a PIMS system that provides control, management, and dissemination of data associated with biomarking and/or annotating regions of interest in images associated with tissue sections and registering the annotated images.

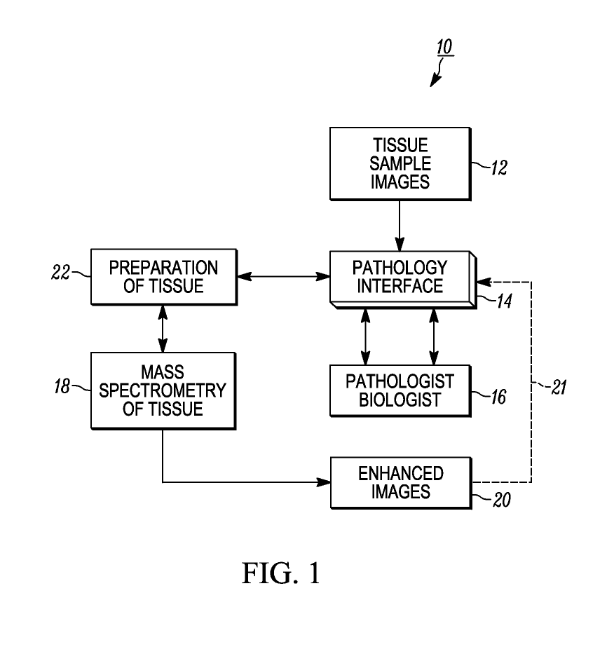

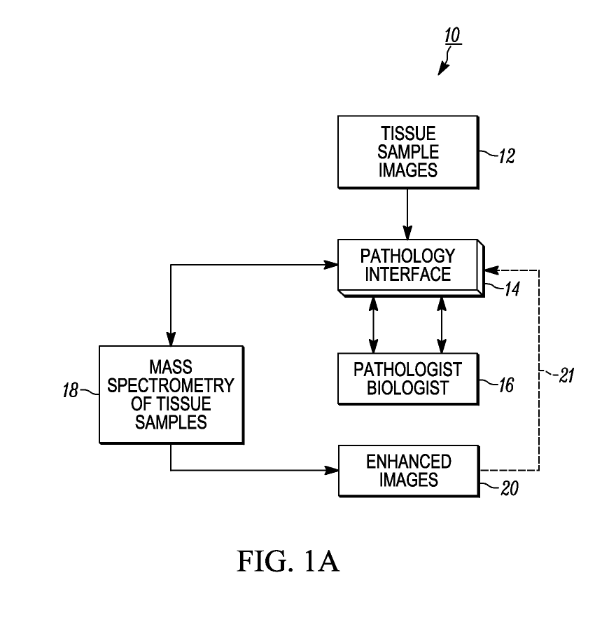

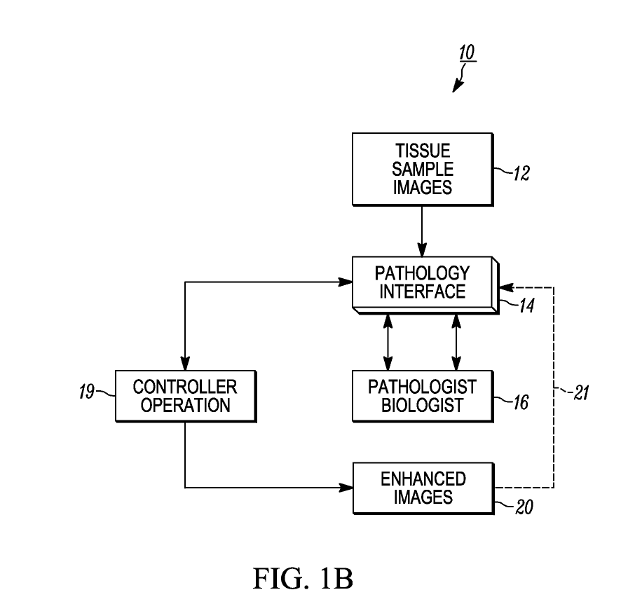

In particular, FIG. 1 illustrates a work-flow diagram of a pathology interface system 10 in accordance with one example embodiment of the present disclosure. In this illustrated example embodiment, the pathology interface system 10 includes an pathology interface 14 that allows a pathologist and/or a biologist 16 with no mass spectrometry (“MS”) experience to control 22 the preparation of the tissue and acquisition of MS 18 data from the tissue.

In particular, the work-flow diagram comprising the pathology interface system 10 is initiated with the tissue sectioning to obtain images of tissue samples 12. The tissue samples 12 can include, but are not limited to, human tissue, animal tissue, and/or tumor bearing tissue. The tissue samples 12 may also include individual cells or a cluster of cells, and further include, but are not limited to, brain cell tissue, prostate cell tissue, or colon cell tissue. It should be appreciated that the tissue samples 12 can further be stored or preserved in any number of ways. For example, in one example embodiment, the tissue samples 12 are frozen-fresh tissue. While in yet another example embodiment, the tissue samples 12 are formalin-fixed tissue, paraffin-embedded tissues, and/or the like.

If the specimen or tissue 12 is a tumor-bearing tissue, the techniques described herein may be used in intra-operative assessment of the surgical margins of tumors. In one embodiment, the specimen or tissue samples 12 may include cancerous tissue. Some examples of cancer tissues that may be analyzed include, but are not limited to, testicular, prostate, lung, breast, colon, skin, and brain cancer. In other embodiments, the tissue may be normal. Tissue specimens 12 may be obtained by any means known in the art, including surgical means. If a tissue 12 is obtained surgically, it is advantageous that the tissue be intact and the location of the tissue be known prior to removal. The tissue sample 12 may be obtained from tissue grown in any medium, and the tissue obtained may be stored for later analysis for an indefinite period according to methods known in the art. With the benefit of this disclosure, those having skill in the art will recognize that other types of specimens and tissue may be analyzed using the very techniques described herein, without insubstantial modifications.

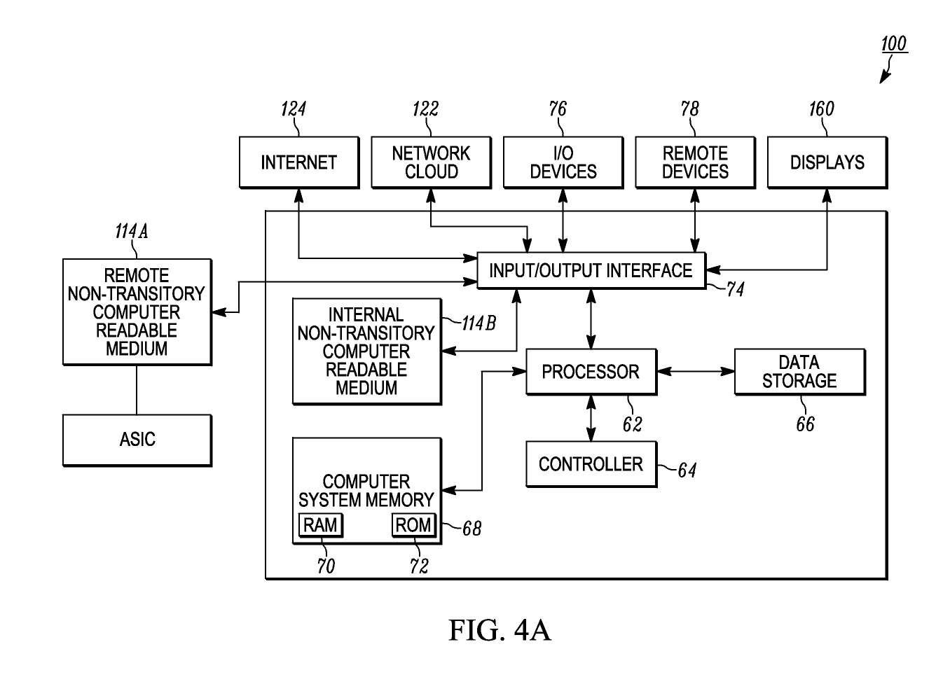

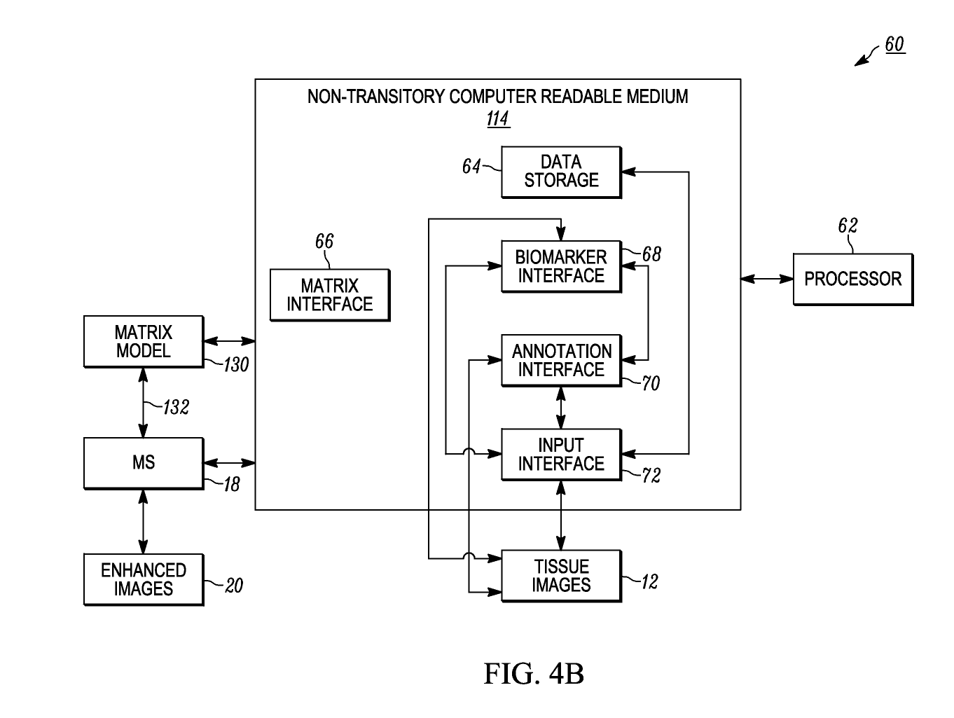

Electronic images of the tissue samples 12 as described above are sent to, or accessible by the pathology interface 14. In one example embodiment, the pathology interface 14 is a computer readable medium 114 as used herein refers to a medium or media that participates in providing instructions to the computer 100 (see FIG. 4), having a processor for execution. In another example embodiment, the computer readable medium 114 is software running on a designated and/or remote platforms having separate processing capabilities. Alternatively, the computer readable medium 114 is hardware such as an application specific integrated circuit (“ASIC”), or is a combination software running on a processor and ASIC.

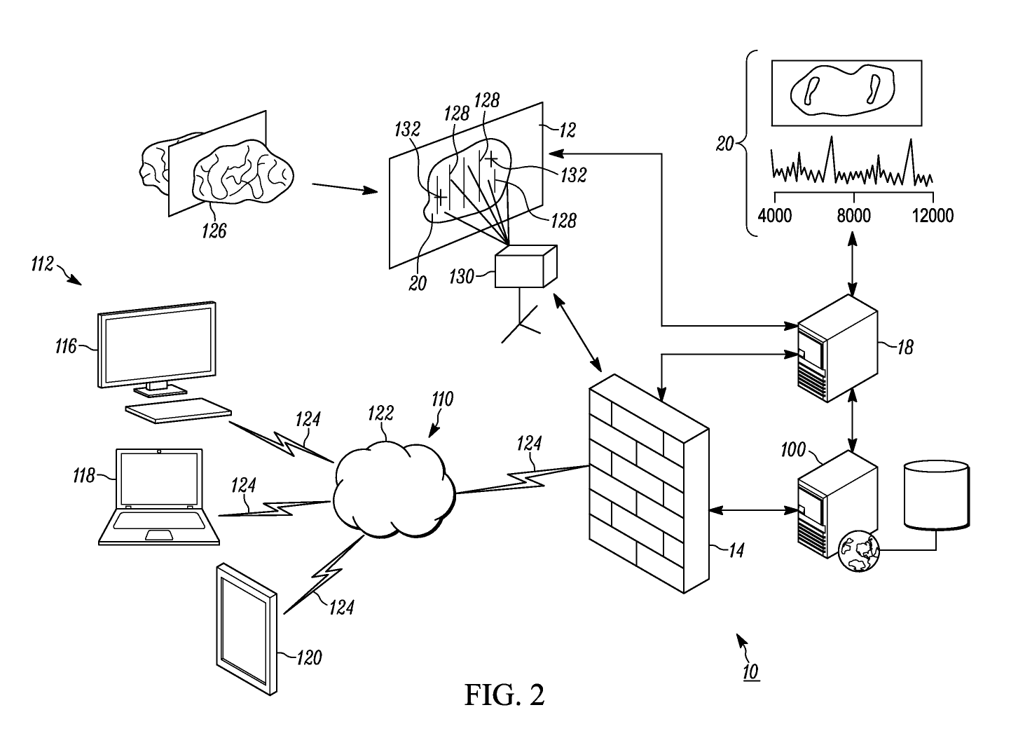

In yet another example embodiment, the computer readable medium 114 can be internal 114A or external 114B to the computer 100, or a network of computers and computing devices, local and wide area networks, remote storage clouds, and remote server web-linked computers such as the Internet, all collectively acting as a computer system 110, as illustrated in the example embodiment of FIG. 2. It will thus be appreciated, a computer readable medium 114 is non-transitory and can include multiple discrete media that are operatively connected to the processing unit, for example, via one or more of a local bus or a network connection.

It should be appreciated by those of ordinary skill in the art that the electronic images of the tissue samples 12 are in the form of digital files of micrographs or low resolution photographs. In addition, such electronic images could be standard brightfield micrographs, or requires a specific stain, filter, or other specialized method of visualization. Some electronic images of the tissue samples 12 are provided to the pathology interface 14 in such a manner that no magnification or staining is required, but the images include areas of interest that can be seen by the naked eye by simple photography, such as nodules formed on the tissue.

Referring again to the example embodiment of FIG. 1, the tissue samples 12 are sent to, or accessed by a pathologist and/or biologist 16 via the pathology interface 14. Once the samples 12 are accessible to the pathologist and/or biologist (hereiafter “medical personnel”), the medical personnel can control via the pathology interface 14 the data acquisition of the MS 18 process that will occur to the tissue samples to create enhanced images 20. In an alternative example embodiment, the enhanced images are received by the pathology interface 14 at 21 and then are accessible or sent by the pathology interface to the pathologist/biologist.

Referring now to FIG. 1A is another example embodiment of a work-flow diagram of a pathology interface system constructed in accordance with another example embodiment of the present disclosure. In FIG. 1A, the operation of the work-flow is generally the same as FIG. 1, save for the step of preparing tissue samples 22.

In the example embodiment of FIG. 1A, the pathology interface is using, for example, tissue sample 12 images that are mounted on a matrix pre-coated or reagent pre-fabricated targets for the MS operation at 18. Moreover, the imaging techniques in this example embodiment could include, for example, DESI, DART, LAESI, and the like. In an alternative example embodiment, the enhanced images are received by the pathology interface 14 at 21 and then are accessible or sent by the pathology interface to the pathologist/biologist.

Referring now to FIG. 1B is another example embodiment of a work-flow diagram of a pathology interface system constructed in accordance with another example embodiment of the present disclosure. In FIG. 1B, the operation of the work-flow is generally the same as FIG. 1A, save for the step of use of the MS upon the tissue sample 12 images 12. In this embodiment, the pathology interface performs a controlled operation 19 other than MS to obtained enhanced images 20. The controlled operation 19 could be, for example, laser microdissection. Alternatively, the controlled operation is laser microdissection in combination with MS, MALDI MS, or LC/MS. Further the controlled operation 19 could be used in laser microdissection for the enhancement of research relating to genetics RNA and/or DNA research.

Illustrated in FIG. 2 is pathology interface system 10 utilized by a computer system 110 of remote users 112 in accordance with another example embodiment of the present disclosure. The computer system 110 is in communication with the pathology interface 14 and operating computer 100. The computer system 110 includes desktop 116, laptop 118, tablet hand-held personal computing device 120, and the like, running on any number of known operating systems and are accessible for communication with remote data storage, such as a cloud 122 and to the pathology interface 14 host operating computer 100 via a world-wide-web or Internet 124.

A specimen 126 for providing tissue samples 12 becomes accessible to the computer system 110 via the operating computer 100. Stated another way, a user such as medical personnel can use the computer system 110 to view micrographed tissue samples 12 and further control the acquisition of data executed by the MS 18 through the pathology interface 14. In particular, the user of the computer system 110 in the example embodiment of FIG. 2 using the pathology interface 14 controls positioning of chemistry such as biomarkers or reagents 128 on the tissue samples using a robotic matrix instrument (spotter or sprayer) 130. The pathology interface 14 controls the MS 18 to make enhanced images 20 from the prepared samples 12. Users of the computer system 110 such as the medical personnel and/or doctors can then view the enhanced images 20 for collaborative diagnostic or treatment purposes. Therefore, in the example embodiment of FIG. 2, the pathology interface 14 functions as an image server that permits remote viewing and data acquisition of high resolution micrographs anywhere in the world via the web network 124 without the need of any specific software on the users' computer.

The users and medical personnel access, as described in FIG. 2, the computer system 110 and control the acquisition of data through the MS 18. This control is performed (either remotely or locally) by controlling the robotic matrix's 130 positioning of the chemistry 128 on the specimen using the high resolution micrographs 12, which directs the MS' 18 execution to form the enhanced images 20. In one example embodiment, the robotic matrix 130 uses a focused acoustic ejector to position the chemistry 128 to the micrographed specimen with matrix droplets of 120 pL at a target area selected by the medical personnel. The MS 18 in one example embodiment is an Ultraflex II (manufactured by Bruker Daltonics, Billerica, Mass.) equipped with a SmartBeam laser and operated using a standard or an automated linear-mode acquisition.

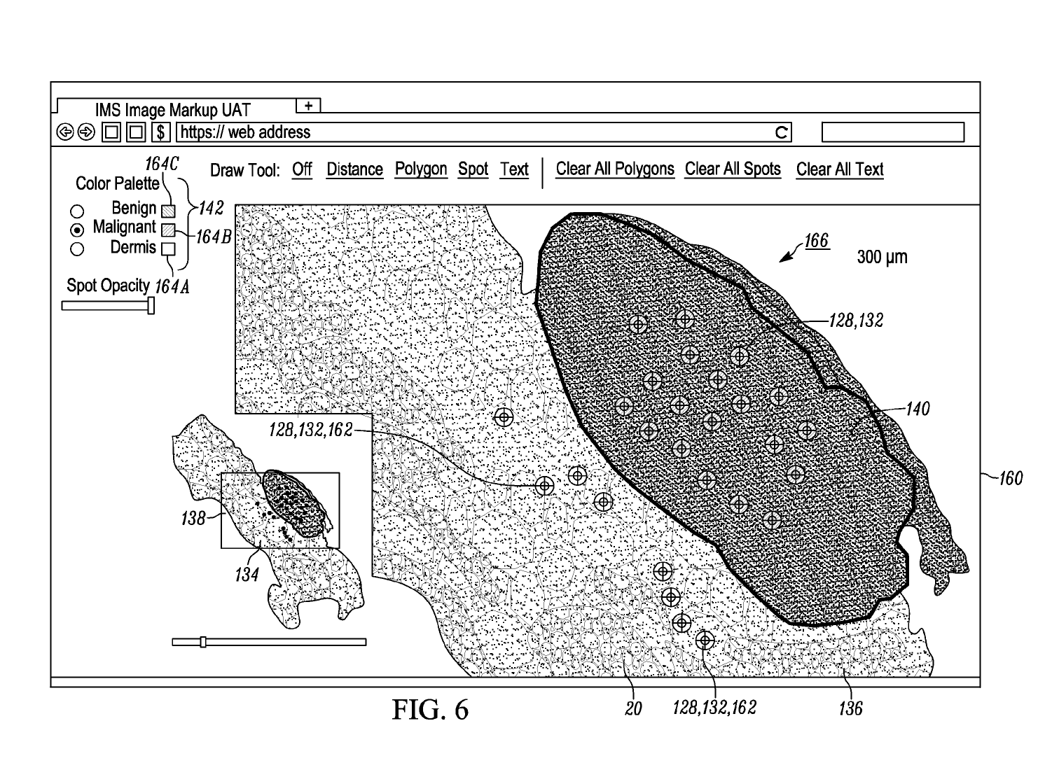

The pathology interface's 14 positioning of the chemistry 128, such as reagents and biomarkers on the electronic images of the micrographed or photographed tissue samples 12 can further include annotations to form a coordinate matrix 132 for the robotic matrix instrument 130 and for controlling the MS 18 in the production of the enhanced images 20. Illustrated in FIG. 6 is a tissue sample 12 of an enhanced image 20 created by the MS 18 using the pathology interface 14 in accordance with one example embodiment of the present disclosure. The enhanced image 20 is illustrated on a display 160 of a computer from the computer system 110 and includes biomarkers 128 positioned by the medical personnel using the pathology interface 14 that act as the matrix coordinates 132.

The enhanced image 20 generated by the pathology interface 14 includes a smaller window view 134 of the tissue sample 12 and a magnified window view 136 of a user selectable area 138 near a tumor 140. The pathology interface 14 further provides the user or medical personnel with annotations 142 that may describe locations or conditions of the locations of the matrix and biomarkers 128.

In one example embodiment, the annotations 142 can be in any shape or dimension and positioned at any location on the electronic image of the tissue sample 12. The user or medical personnel can create custom annotations that become meta data 162 that can be captured by the system 10 and recognized by the interface 14. In addition, users or medical personnel can define any number of classes and subclasses 164 on the electronic images 166. The classes and subclasses 164 can be uniquely color coded and drive the comparison of these unique areas of interest by the molecular data derived from the experiment or MS scan.

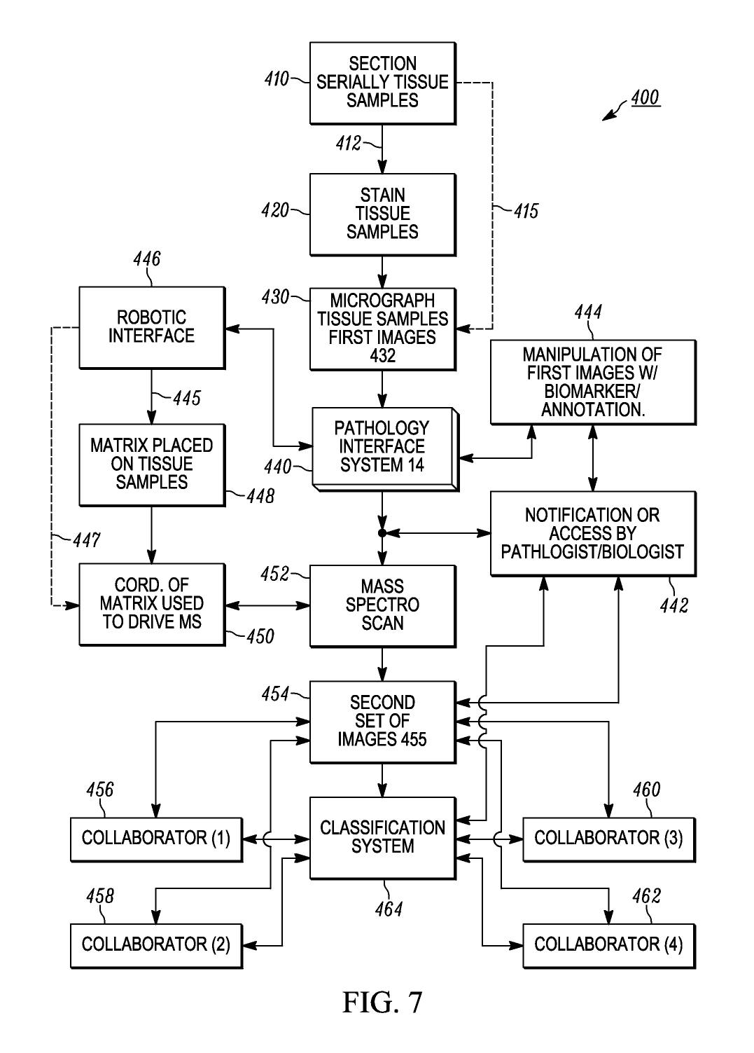

In another example embodiment, the annotations 142 are linked to medical records and/or are used in electronically delivered pathology reports. While in another example embodiment, the annotations 142 and classes and subclasses 164 provide meta data, which all three modes of information can be used in a classification system 464, 564, respectively in FIGS. 7 and 8 for diagnostic and/or treatment analysis.

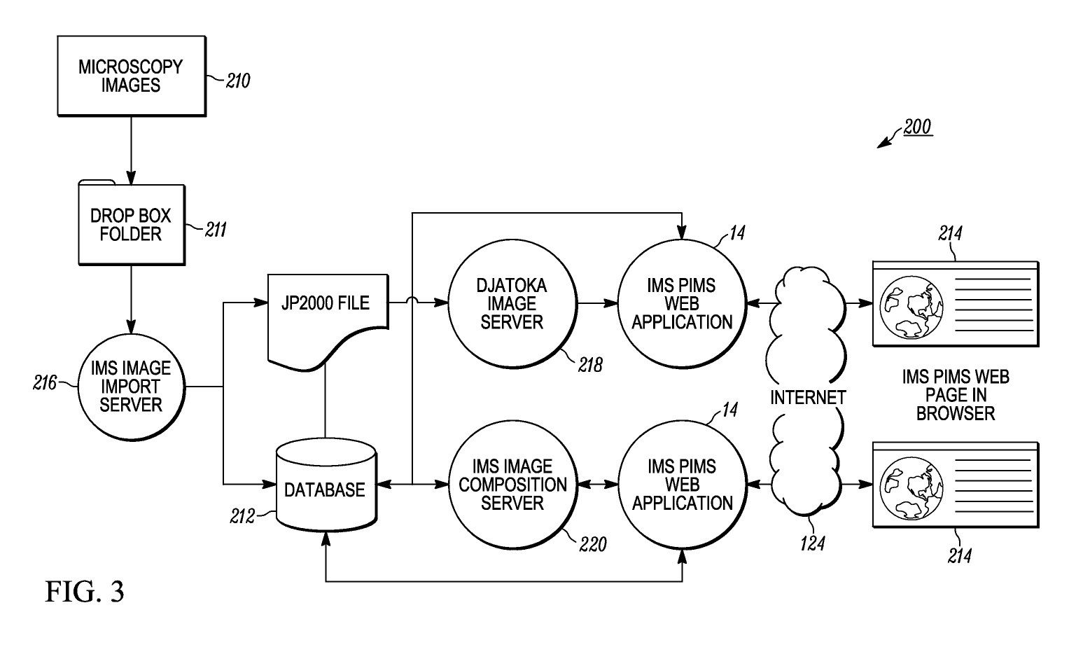

Referring now to FIG. 3 is a work-flow diagram of a pathology interface 14 as utilized by computer network 200 in accordance with another example embodiment of the present disclosure. The work-flow includes storing of microscopy images 210 in a database, such as a drop box folder 211. The drop box folder 211 is in communication with a database 212 is operated and in communication with the pathology interface 14, which in the illustrated example embodiment is a web application operating through the Internet 124 and provides users and medical personnel with a (secured HIPAA compliant) webpage and browser interface 214. A MS 18 image import server 216 supports the network 200 and is in communication with the pathology interface 14. The image import server 216 employing the pathology interface 14 detects tissue sample 12 files, converts the file type (for example TIFF to JP2000), adds metadata to the database 212 for each file, associates sample 12 by filename, and associates the sample to a project by a folder name. The import server 216 and pathology interface 14 is in communication with an image server 218 and composition server 220. The image 218 server through the pathology interface 14 generates scaled portions of the image in tiles to the users. The composition server 220 employs the pathology interface 14 to scale and crop images for viewport overlay with annotations as requested for download and prepares annotated full images for MS 18 imaging.

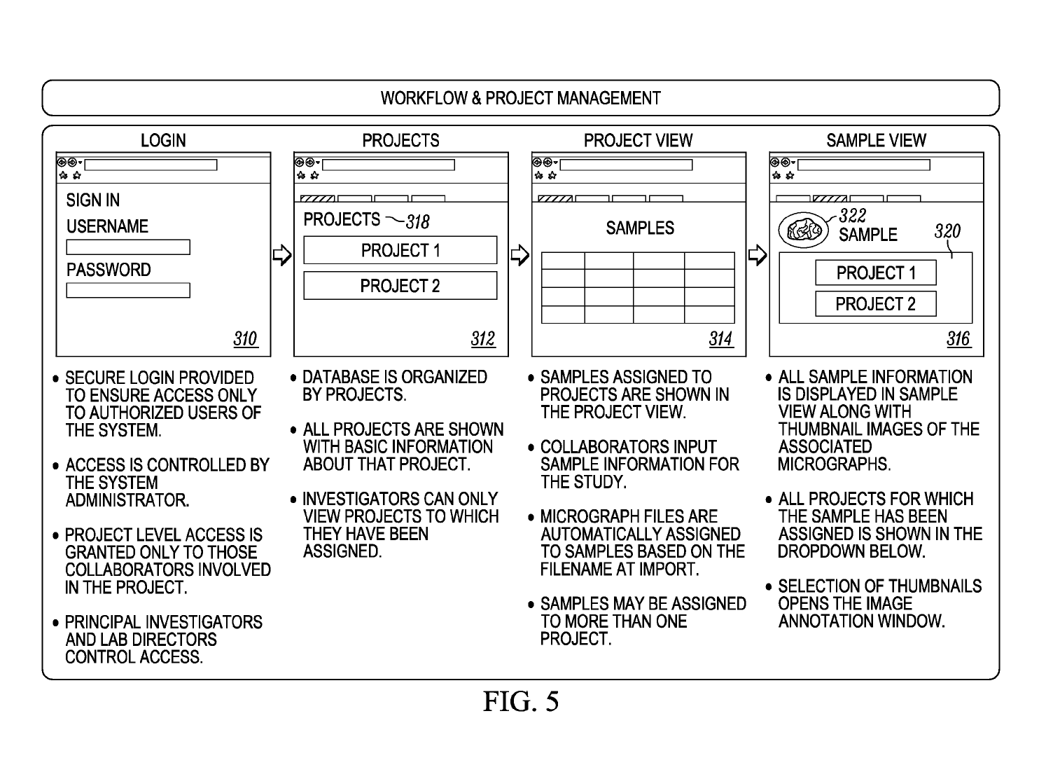

Illustrated in FIG. 5 is a work-flow project management program 300 utilizing a pathology interface 14 system in accordance with one example embodiment of the present disclosure. The project management program 300 exemplifies the user or medical personnel web interface 214 found in a computer system either remote or local to the MS 18 system.

In the illustrated example embodiment, the project management program 300 through the pathology interface 14 provides four different user operation views 310, 312, 314, and 316. The first view 310 includes a secure login for the user or medical personnel to insure access to only authorized users of the project management program 300, which is controlled by the system administrator. Access at the first view 310 is limited to those users or collaborators involved with a project and only gain access to projects authorized by the system administrator.

The second view 312 includes a database 212 that is organized by projects 318. Each project 318 may relate to an individual or set of patients, test, tumor, sample, and the like, with basic information shown on the second view 312 about the project, such as identification data. Users, collaborators, and medical personnel can only view projects in the database 212 which they have been assigned.

The third view 314 is a project view that allows samples to connect to each project 318. It is in this third view 314 that users, collaborators, or medical personnel can input sample information for the study. In the third view 314, micrograph samples 12 are automatically assigned to samples 12 based on the filename and import by the pathology interface 14. In addition, samples 12 can be assigned to more than one project 318.

The fourth view 316 includes a sample view that all information relating to a particular sample 12 is displayed via the pathology interface 14, including thumbnail images 322 of the associated micrographs. Also within this fourth view, all projects 318 for which the sample has been assigned is shown in a dropdown window 320. Selection of the thumbnail image 322 opens the image annotation window 320.

Illustrated in FIG. 4A is a computer system 100 used to implement a pathology interface system 60 in accordance with one example embodiment of the present disclosure. The computer system 100 comprises a processor 62, a controller 64, data storage 66, computer system memory 68 that includes read-accessible-memory (“RAM”), read-only-memory (“ROM”) and an input/output interface 74. The computer system 100 executes instructions from the pathology interface 14 by non-transitory computer readable medium either internal 114B or external 114A through the processor 62 that communicates to the processor via input interface 74. The computer system 100 communicates with the Internet 124, a network such as a LAN, WAN, and/or a cloud 122, input/output devices 76 such as flash drives, remote devices 78 such as a robotic matrix sprayer or spotter, and displays 160 such as a monitor.

Shown in FIG. 4B is a block diagram of a pathology interface system 60 used to control data acquisition from tissue 12 using a MS 18 in accordance with one example embodiment of the present disclosure. In the illustrated example embodiment, the system 60 is in communication with a processor 62 that can control (via instructions from the pathology interface 14) the operation of the system and a matrix model 130 that influences the operation and control (via communication) of a MS 18. The system 60 further comprises data storage 64, a matrix interface 66, a biomarker interface 68, annotation interface 70, and an input interface 72. In the illustrated example embodiment, the system 60 is controlled through the non-transitory computer readable medium 114.

During operation, the system 60 can receive tissue images 12 from the input interface 72, which then applies chemistry 128 (such as biomarkers and/or reagents) to the tissue images with the biomarker interface 68 and annotation interface 70 to apply a matrix 132 using a spotter or sprayer directed at the tissues using the system's matrix interface 66. A MS 18 is then controlled based on the matrix 132 coordinates on the tissues to form the enhanced images 20. In the illustrated example embodiment, the MS 18 is in communication with the system 60.

FIG. 7 is a work-flow diagram of a pathology interface process 400 in accordance with one example embodiment of the present disclosure. The process 400 is initiated by the serial sectioning of tissue samples at 410. It will be appreciated by those of ordinary skill in the art that other forms or methods of obtaining tissue samples 12 are intended to be within the spirit and scope of the present disclosure. At 420, the tissue samples 12 are stained then advanced to 430 to generate micrographed first set of images 432.

In the illustrated example embodiment, the process 400 is controlled by the pathology interface 14 at 440. The pathology interface 14 receives and/or stores the first set images 432. At which time, medical personnel can access or is notified that the first set of images 432 are available for viewing at 442. Upon viewing the first set of images 432, the medical personnel (either locally or remotely) can control the acquisition of data from a mass spectrometer by applying chemistry 128, such as matrix or other reagents, annotations, and matrix coordinates to the images at 444 under the instructions and operation provided by the pathology interface 14. The annotations are used to apply matrix or reagents to specific regions of the tissue, directed by the pathology interface 14.

Once the application of annotations on the first set of images is complete at 444, the pathology interface 14 communicates using a robotic interface 446 for positioning of a matrix in the region of interest (identified by the medical personnel) on the tissue samples 12 at 448. The coordinates of the matrix 132 are then used at 450 to operate a MS 18 to generate one or more scans of the sample 12 at 452. The scanning by the MS 18 then generates a second set of images 455 at 454.

Using the second set of images 455 at 454, the pathology interface 14 provides access to local and/or remote collaborators 456, 458, 460, and 462, including the medical personnel, which will use the second set of images for example, diagnostic or treatment purposes. The second set of images 455 in the illustrated example embodiment are further utilized in a remote classification system 464, which compares the second set of images 455 with images in a database of the classification system for diagnostic and treatment analysis.

In another alternative work-flow example embodiment of the interface process 400 avoids the staining operation of the tissue samples at 420, and uses unstained or pretreated tissues at 415 to create the first electronic images at 430. Thus, the paths 412 and 445 are avoided.

In yet another alternative work-flow example embodiment of the interface process 400, the electronic tissue are used to guide the analysis of tissue placed onto matrix precoated targets 12. Thus, the step 445 is avoided along with the placement of the matrix on the tissue sample images at 448. A robotic interface 446 facilitates along step 447 the coordinates the matrix of the precoated tissue images to the MS operation to form a second set of electronic images 455.

FIG. 8 is a work-flow diagram of a pathology interface process 500 in accordance with another example embodiment. The process 500 is initiated by the serial sectioning of tissue samples at 510. It will be appreciated by those of ordinary skill in the art that other forms or methods of obtaining tissue samples 12 are intended to be within the spirit and scope of the present disclosure. At 512 and 514, the tissue samples 12 are divided serially between a Group A and Group B. The division of the samples 12 into the two grouping is effective for MS systems that operate well by the positioning of a matrix or coordinates on stained tissue. As a result, in the illustrated example embodiment, only Group A is stained at 520 and then advanced to 530 to generate micrographed first set of images 532.

In the illustrated example embodiment, the process 500 is controlled by the pathology interface 14 at 540. The pathology interface 14 receives and/or stores the first set images 532. At which time, medical personnel can access or is notified that the first set of images 532 are available for viewing at 542. Upon viewing the first set of images 532, the medical personnel (either locally or remotely) can control the acquisition of data from a mass spectrometer by applying annotations, and matrix coordinates to the images at 544 under the instructions and operation provided by the pathology interface 14.

Once the application of annotations on the first set of images 532 is complete at 544, the pathology interface 14 communicates using a robotic interface 546 for positioning of a matrix in the region of interest (identified by the medical personnel) on the unstained Group B tissue samples 12 at 548. The coordinates of the matrix 132 are then used at 550 to operate a MS 18 to generate one or more scans of the unstained Group A samples 12 at 552. The scanning by the MS 18 then generates a second set of images 555 at 554.

Using the second set of images at 555, the pathology interface 14 provides access to local and/or remote collaborators 556, 558, 560, and 562, including the medical personnel, which will use the second set of images for example, diagnostic or treatment purposes. The second set of images 555 in the illustrated example embodiment are further utilized in a remote classification system 564, which compares the images 555 with images in a database of the classification system for diagnostic and treatment analysis.

In an alternative work-flow example embodiment of the interface process 500, the placement of the matrix on Group B is not necessary. Thus, the step 545, robotic interface 546, and placement of the matrix on Group B at 548 is avoided. Accordingly, samples from Group B then flow from 514 along 547 to the positioning by the pathology interface 14 of coordinates upon the areas of interest to the pathologist to drive the MS at 550.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A system for controlling the acquisition of data from at least one tissue sample comprising:
a pathology interface for receiving at least one tissue sample and providing said at least one tissue sample to a user, the pathology interface configured to position at least one coordinate of interest for the acquisition of data on said at least one tissue sample; and
the pathology interface configured to perform a controlled operation relating to said at least one coordinate of interest to provide an enhanced image about said coordinate of interest.

2. The system of claim 1 wherein said controlled operation comprises mass spectrometry of said coordinates of interest on at least one tissue sample.

3. The system of claim 1 wherein said controlled operation comprises laser microdissection of said coordinates of interest on at least one tissue sample.

4. The system of claim 1 wherein said controlled operation comprises a combination of laser microdissection and mass spectrometry of said coordinates of interest on at least one tissue sample.

5. The system of claim 1 wherein the pathology interface provides for the positioning of the coordinate of interest on said at least one tissue sample remotely from the location of the at least one tissue sample via a world-wide-web.

6. The system of claim 1 wherein said enhanced image is accessible to a plurality of users via a world-wide-web.

7. The system of claim 1 wherein said pathology interface further comprises a non-transitory computer readable medium storing machine executable instructions executable by a processor for positioning said coordinates of interest on said at least one tissue sample.

8. The system of claim 7 wherein said enhanced image is an electronic image meta data provided by the pathology interface during said controlled operation.

9. A non-transitory computer readable medium storing machine executable instructions for tissue imaging comprising:
an input interface configured to receive a plurality of tissue images, the input interface generating enhanced resolution images from said plurality of tissue images for viewing;
an annotation interface for positioning coordinates of interest on said enhanced resolution images; and
a matrix model configured to evaluate said coordinates of interest on said enhanced resolutions to generate discrete coordinates, the matrix model using said discrete coordinates in performing mass spectrometer analysis to form at least one viewing image.

10. The non-transitory computer readable medium of claim 9 wherein said at least one viewing image is stored in database capable of remote access.

11. The non-transitory computer readable medium of claim 9 wherein said at least one viewing image contains meta data acquired from said annotation interface and/or molecular analysis of the annotated tissue images, the meta data providing diagnostic information for comparison with a remote classification system.

12. A method of tissue imaging, the method comprising the steps of:
configuring a pathology interface to receive a plurality of tissue images, the interface generating enhanced resolution images from said plurality of tissue images for viewing; and
evaluating coordinates of interest on said enhanced resolutions with a matrix model configured to generate discrete coordinates, and the matrix model using said discrete coordinates to perform mass spectrometer analysis to form at least one viewing image.

13. The method of claim 12 further comprising the step of positioning said coordinates of interest with an annotation interface on said enhanced resolution images.

14. The method of claim 12 further comprising the step of displaying the viewing image to a user.

15. A diagnostic system comprising:
a processor;
a display; and
a non-transitory computer readable medium storing machine executable instructions executable by the processor for altering tissue images, the instructions comprising:
an input interface configured to receive a plurality of tissue images, the input interface generating enhanced resolution images from said plurality of tissue images for viewing; and
a matrix model configured to evaluate coordinates of interest on said enhanced resolutions to generate discrete coordinates, the matrix model using said discrete coordinates in performing mass spectrometer analysis to form at least one viewing image.

16. The diagnostic system of claim 15 further comprising an annotation interface for positioning said coordinates of interest on said enhanced resolution images.

17. The diagnostic system of claim 15 further comprising a user interface configured to provide at least one viewing image to a user at the display.
